(19) United States
(12) Patent Application Publication
(10) Pub. No.: US 2008/0170822 A1
(43) Pub. Date: Jul. 17, 2008

(54) OPTICAL WAVEGUIDE

(76) Inventors: Yu-Dong BAE, Suwon-si (KR); Jeong-Seok Lee, Anyang-si (KR); Jeong-Hwan Song, Seoul (KR)

Correspondence Address: CHA & REITER, LLC, 210 ROUTE 4 EAST STE 103, PARAMUS, NJ, 07652, US

(21) Appl. No.: 11/971,248

(22) Filed: Jan. 9, 2008

(30) Foreign Application Priority Data
Jan. 11, 2007 (KR) 2007-3296

(51) Int. Cl. G02B 6/26

(52) U.S. Cl. 385/18

(57) ABSTRACT

An optical waveguide and method of providing that enhances high-speed communication includes a waveguide medium having at least one groove, in which a side wall exposed by the groove is formed inclined with respect to the traveling path of light. A reflection block having a reflection mirror faces the inclined side wall of the groove, in which the reflection block is typically arranged in the groove to face the side wall of the groove, and a refractive index matching layer is typically a coating arranged between the side wall of the groove and the reflection mirror.

### CLAIM OF PRIORITY

This application claims the benefit of priority under 35 U.S.C. §119(a) from a Korean Patent Application filed in the Korean Intellectual Property Office on Jan. 11, 2007 and assigned Serial No. 2007-3296, the entire disclosure of which is hereby incorporated by reference in its entirety.

### BACKGROUND OF THE INVENTION

1. Field of the Invention

The present invention generally relates to an optical waveguide that can be used for high-speed communications. More particularly, the present invention relates to an optical waveguide having the capability of r switching a path of light coupled into the optical waveguide.

2. Description of the Related Art

Recently, portable communication terminals or portable digital devices have evolved to now include a visual and/or multimedia function. To support the multimedia function, which requires significant amounts of data to be to be transmitted/received, there is a need for high-speed and voluminous data processing not previously provided to devices such as portable communication terminals.

Optical communication, in which data is transmitted using light, can transmit/receive voluminous data as compared to electrical data transmission. Transmitting data using light typically includes an optoelectric component substrate in which an optical waveguide and optoelectric conversion devices are mounted in an electric flexible printed circuit board.

In a general optoelectric component substrate, an optical waveguide is mounted on a bottom face of a flexible printed circuit board, whereas the optoelectric conversion devices are mounted on a top face of the flexible printed circuit board. The optoelectric component substrate includes a means for wave-guiding light generated from the optoelectric conversion devices through the optical waveguide and inputting the wave-guided light into the optoelectric conversion devices.

In the optical waveguide, a face that is inclined with respect to the wave-guiding direction for coupling and direction-switching of the light is formed by blade sawing, and a reflection mirror is formed in the inclined face by applying a coating using a metal material, such as, for example, Au.

However, there is a problem with an inclined face formed by blade sawing because there is not likely to be a uniform roughness. As a result, light reflected from the reflection mirror may deviate from a path or may be lost.

### SUMMARY OF THE INVENTION

An aspect of the present invention is to address in part at least some of the above problems and/or disadvantages and to provide at least the advantages described below. Accordingly, an aspect of the present invention is to provide an optical waveguide having a reflection mirror for minimizing a loss of light.

According to one exemplary aspect of the present invention, there is provided an optical waveguide including a waveguide medium having at least one groove, in which a side wall exposed by the groove is formed on an inclination with respect to a traveling path of light, and a reflection block having a reflection mirror faces the inclined side wall of the groove, in which the reflection block is inserted into the groove in such a way to face the side wall of the groove. A refractive index matching layer is coated between the side wall of the groove and the reflection mirror.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 is a cross-sectional view of an optical waveguide according to a first exemplary embodiment of the present invention; and

FIG. 2 is a cross-sectional view of an optical waveguide according to a second exemplary embodiment of the present invention.

### DETAILED DESCRIPTION OF THE INVENTION

The matters defined in the description, such as a detailed construction and elements thereof, are provided to assist a person of ordinary skill in the art in a comprehensive understanding of exemplary embodiments of the invention. Accordingly, the person of ordinary skill in the art will recognize that various changes and modifications to the exemplary embodiments described herein can be made without departing from the spirit of the invention and the scope of the appended claims. Also, descriptions of well-known functions and constructions may be omitted for clarity and conciseness when their inclusion would obscure appreciation of the invention with a description of such well-known functions and constructions.

Throughout the drawings, the same drawing reference numerals will be understood to refer to the same elements, features and structures.

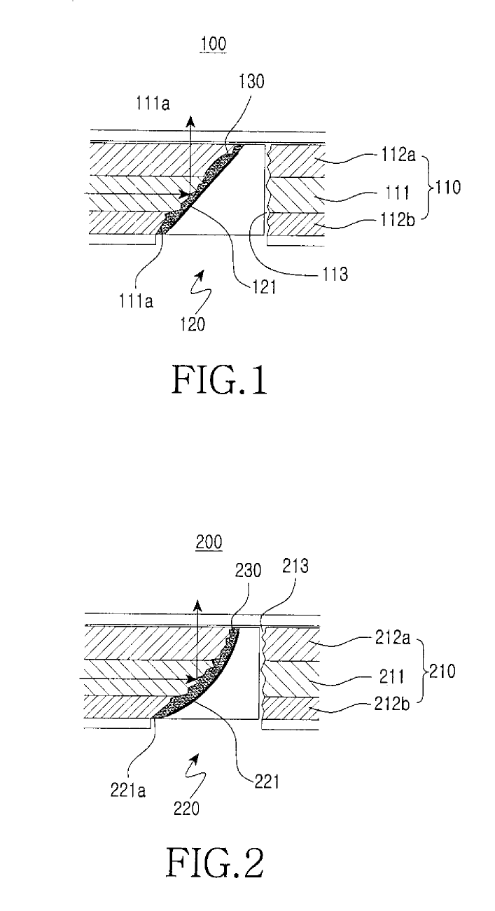

FIG. 1 is a cross-sectional view of an optical waveguide 100 according to a first exemplary embodiment of the present invention. Referring to FIG. 1, the optical waveguide 100 typically includes a waveguide medium 110, a reflection block 120 for reflecting light perpendicular to, or at a predetermined angle relative to, the traveling path of light that is wave-guided into the waveguide medium 110. A refractive index matching layer 130 is coated between the waveguide medium 110 and the reflection block 120 in order to combine the reflection block 120 with the waveguide medium 110.

Still referring to the example shown in FIG. 1, the waveguide medium 110 includes at least one groove 113, a core 111, a lower clad 112b under the core 111, and an upper clad 112a on the core 111. The groove 113 exposes a side wall 111a of the core 111, the lower clad 112b, and the upper clad 112a, and the exposed side wall 111a that may be formed on an incline with respect to the traveling path of light.

The core 111 is formed of a material having a higher refractive index than those of the upper clad 112a and the lower clad 112b in order to cause the light coupled into the core 111 to be totally reflected between the upper clad 112a and the lower clad 112b and thus for the light to be wave-guided inside the core 111. The upper clad 112a and the lower clad 112b may be grown on the top surface and the bottom surface of the core 111, respectively, in order to be preferably symmetrical with each other with respect to the core 111.

The side wall 111a of the core 111, the upper clad 112a, and the lower clad 112b are exposed to the outside by the groove 113. In addition, the side wall 111a of the waveguide medium 110, which is exposed by the groove 113, may be formed with an incline at a predetermined angle with respect to the traveling path of light.

The reflection block 120 also typically includes a reflection mirror 121 facing the inclined side wall 111a of the waveguide medium 110, and the reflection mirror 121 is inserted into the groove 113 to face the side wall 111a of the groove 113. The reflection mirror 121 may be formed by depositing a metal material on a surface of the reflection block 120, which faces the side wall 111a. The reflection mirror 121 may also comprise a semiconductor chip made by semiconductor processing. The side wall 111a and the reflection mirror 121 may be inclined at the same angle. For example, the side wall 111a and the reflection mirror 121 may each be inclined at 45° relative to a common axis, such as a traveling path of light.

Still referring to FIG. 1, the traveling path of light wave-guided through the waveguide medium 110 is switched due to reflection by the reflection mirror 121. In other words, since the side wall 111a, which is exposed by the groove 113 of the waveguide medium 110, and the reflection mirror 121 are typically both inclined at a similar predetermined angle, light that is wave-guided into the waveguide medium 110 can be reflected by the reflection mirror 121.

As shown in FIG. 1, the refractive index matching layer 130 is coated between the side wall 111a of the groove 113 and the reflection mirror 121 in order to compensate for a difference between refractive indices of the waveguide medium 110 and the reflection mirror 121, thereby minimizing a loss of light during a process in which light is incident to the reflection mirror 112 from the side wall 111a and is then reflected by the reflection mirror 121. The refractive index matching layer 130 may be formed of a material having a refractive index that can minimize a difference between the refractive index of the core 111, in which light is wave-guided, and the refractive index of the reflection mirror 121 by which light is reflected. For example, the refractive index matching layer 130 may be formed of optical transparent epoxy or an ultraviolet hardener for adhesion between optical systems. It is preferable that the refractive index matching layer 130 is formed of a material having the same refractive index as that of the core 111, but may the refractive index matching layer may also be formed of a material having a similar refractive index to that of the core 111.

FIG. 2 is a cross-sectional view of an optical waveguide 200 according to a second exemplary embodiment of the present invention. Referring to FIG. 2, the optical waveguide 200 includes a waveguide medium 210 for wave-guiding light incident into a lateral face in a longitudinal direction, a reflection block 220 for reflecting light, perpendicular to, or at a predetermined angle relative to the traveling path of light that is wave-guided into the waveguide medium 210, and a refractive index matching layer 230 is coated between the waveguide medium 210 and a reflection mirror 221 in order to combine the reflection block 220 with the waveguide medium 210.

The waveguide medium 210 includes a core 211, an upper clad 212a, a lower clad 212b, and a groove 213 into which the reflection block 220 can be inserted.

Still referring to FIG. 2, the reflection block 220 is inserted into the groove 213 and includes the reflection mirror 221 formed in a surface facing a side wall 221a of the waveguide medium 210.

The side wall 221a of the waveguide medium 210, which is opened by the groove 213, is formed inclined at a predetermined angle, and a surface of the reflection block 220 in which the reflection mirror 221 is formed may be curved with a predetermined curvature.

According to the examples of the present invention, a separate reflection block having a reflection mirror is inserted into a groove of a waveguide medium and a matching layer for refractive index matching is typically coated between a side wall of the groove of the waveguide medium and the reflection block, thereby minimizing a problem caused by weak adhesion of the reflection mirror to the reflection block. Moreover, the reflection block has the reflection mirror of a uniform and low reflection loss, thereby minimizing the reflection loss of light.

While the invention has been shown and described with reference to exemplary embodiments thereof, it will be understood by those skilled in the art that various changes in form and details may be made therein without departing from the spirit of the invention and the scope of the appended claims. For example, the angle of inclination, or the degree of curvature of the surface of the reflection block can be substantially different than shown and described. Additionally, the side wall of the groove and the reflection mirror can be formed inclined at the same angle, similar angles, or substantially different angles or degrees of curvature. For example, similar angles could both be acute or obtuse, or have a distance of degree there between that is acute. Also, the materials used to create the reflection mirror, or the refractive index matching layer can be arranged other than or constructed differently than the description shown and described herein. Finally, when the upper clad is described as being on the core, it is typically above the core or may be directly on the core, and the lower clad/upper clad may be in contact with the core or there could be another surface there between one or both clads. Also, the amount of predetermined curvature may not be uniform.

What is claimed is:

1. An optical waveguide comprising:
a waveguide medium having at least one groove, in which a side wall exposed by the groove is formed at an inclined angle with respect to a traveling path of light through the waveguide;
a reflection block having a reflection mirror facing the inclined side wall of the groove, in which the reflection block is arranged in the groove to face the side wall of the groove; and
a refractive index matching layer arranged between the side wall of the groove and the reflection mirror.

2. The optical waveguide of claim 1, wherein the refractive index matching layer is a coating formed of an optical transparent epoxy or an ultraviolet hardener.

3. The optical waveguide of claim 1, wherein the waveguide medium comprises:
a core,
a lower clad under the core; and
an upper clad above the core.

4. The optical waveguide of claim 3, where the upper clad is arranged on the core to be in contact therewith.

5. The optical waveguide of claim 1, wherein the side wall of the groove and the reflection mirror are formed inclined at the same angle.

6. The optical waveguide of claim 5, where the angle comprises 45 degrees.

7. The optical waveguide of claim 5, where the angle comprises 30 degrees.

8. The optical waveguide of claim 1, wherein the side wall of the groove and the reflection mirror are formed inclined at similar angles.

9. The optical waveguide of claim 1, wherein the side wall of the groove and the reflection mirror are formed inclined at acute angles relative to a traveling path of light.

10. The optical waveguide of claim 1, wherein the reflection mirror is curved with a predetermined curvature.

11. The optical waveguide of claim 10, wherein the predetermined curvature is uniform.

12. The optical waveguide of claim 10, wherein the predetermined curvature is non-uniform.

13. The optical waveguide of claim 1, wherein the reflection mirror comprises a metal or a compound semiconductor.

14. A method of manufacturing an optical waveguide comprising the following steps:
(a) forming a groove at an inclined angle with respect to a traveling path of light through a waveguide medium so that a side wall of the waveguide medium is exposed by the groove;
(b) arranging a reflection block in the groove, said reflection block having a reflection mirror facing the inclined side wall of the groove, in which the reflection block is arranged in the groove to face the side wall of the groove; and
(c) arranging a refractive index matching layer arranged the side wall of the groove and the reflection mirror.

15. The method according to claim 14, wherein the refractive index matching layer comprises a coating formed of an optical transparent epoxy or an ultraviolet hardener arranged between the side wall of the groove and the reflection mirror.

16. The method according to claim 14, wherein the reflection mirror is curved with a predetermined curvature.

17. The method according to claim 16, wherein the predetermined curvature is non-uniform.

18. The method according to claim 16, wherein the predetermined curvature is uniform.

19. The method according to claim 14, wherein the side wall of the groove and the reflection mirror are formed inclined at acute angles relative to a traveling path of light.

20. The method according to claim 14, wherein the side wall of the groove and the reflection mirror are formed inclined at similar angles relative to a traveling path of light.
